(19) United States
(12) Patent Application Publication
(10) Pub. No.: US 2015/0348322 A1
(43) Pub. Date: Dec. 3, 2015

(54) Dynamically Composited Information Handling System Augmented Reality at a Primary Display

(71) Applicant: Dell Products L.P., Round Rock, TX (US)

(72) Inventors: Mark R. Ligameri, Lakeway, TX (US); Richard William Schuckle, Austin, TX (US); Rocco Ancona, Austin, TX (US); Glen Elliott Robson, Austin, TX (US); Michiel Sebastiaan Emanuel Petrus Knoppert, Amsterdam (NL)

(73) Assignee: DELL PRODUCTS L.P., Round Rock, TX (US)

(21) Appl. No.: 14/293,543

(22) Filed: Jun. 2, 2014

(51) Int. Cl. G06T 19/00; G06T 7/00; G02B 27/01

(52) U.S. Cl. CPC G06T 19/006; G02B 27/0172; G02B 27/0101; G06T 7/004; G02B 2027/0138; G02B 2027/014

(57) ABSTRACT

An augmented virtual reality is provided by composite visual information generated at goggles and a display viewed through the goggles. Positional cues at the display and/or goggles provide the relative position of the display to the goggles so that an end user primarily views the display through the goggles at the position of the display. The goggles provide peripheral visual images to support the display visual images and to support end user interactions with input devices used for controlling display and goggle visual images.

### BACKGROUND OF THE INVENTION

1. Field of the Invention

The present invention relates in general to the field of information handling system display presentation, and more particularly to a dynamically composited information handling system augmented reality at a primary display.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are commonly used to play games, often including interactive games in which an end user competes with other players through an Internet interface. The type and complexity of games varies tremendously, often depending upon the processing capability of the information handling system that supports the games. Many simple games are played on portable information handling systems, such as “apps” played on tablets and smartphones. Generally, these more simple games have graphical images that use less-intensive processing so that less-powerful portable information handling systems are capable of presenting the graphical images. Other more complex games are played on information handling systems built specifically for playing games, such as Xbox and Play Station. Specialized information handling systems often include graphics processing capabilities designed to support games with life-like graphical images presented on a high definition television or other type of display. Some of the most complex and life-like games are played on standardized information handling systems that include powerful processing components. For example, WINDOWS or LINUX operating systems run over an INTEL processor to execute a game and present images at one or more displays with the help of powerful graphics processing capabilities. Extreme gaming hardware, such as is available from ALIENWARE, presents life-like images with fluid and responsive movements based upon heavy processing performed by graphics processing units (GPUs).

Recently, a number of head-mounted display goggles have become available that support presentation of game images near the eyes of an end user. Typical head mounted displays fall into a virtual reality classification or an augmented reality classification. Virtual reality displays recreate a virtual world and block the ability to see elements in the real world. Virtual reality head-mounted displays mask the outside world with the goggles that cover the end user's eyes to provide a “separate” world, however, by masking the outside world such goggles prevent the end user from visually interacting with real world tools, such as keyboards, mice, stylus, LCDs, televisions, etc. . . . . For example, the Oculus Rift presents a game to an end user without letting the end user see outside of the goggles. Augmented reality displays typically maintain the real world context and provide bits of additional information to the user, however the information is typically presented in the periphery in a set location without knowledge of how to parse where the information is displayed. For example, the RECON JET provides a heads-up display for sports, such as cycling, triathlons and running.

### SUMMARY OF THE INVENTION

Therefore a need has arisen for a system and method which augments visual images presented at a display with visual images presented by goggles.

In accordance with the present invention, a system and method are provided which substantially reduce the disadvantages and problems associated with previous methods and systems for presenting visual images. Real time compositing across multiple display elements augments a primary display of information as visual images with a secondary display of peripheral information as visual images relative to the primary display.

More specifically, an information handling system generates visual information that a graphics subsystem processes into pixel values to support presentation of visual images at a display and at goggles warn by an end user. The display and/or goggles include positional cues that cameras detect to determine the relative position of the goggles to the display. A compositing engine applies the relative position of the goggles to the display so that the display visual images and goggle visual images are presented in a desired relationship relative to each other. For example, the display visual images pass through the goggles at the position of the display relative to the goggles and the end user wearing the goggles so that the end user views the display visual images in a normal manner. Goggle visual information is generated only outside of the display visual information to create a composite display presentation in which the goggle visual information complements the display visual information. As the goggles move relative to the display, the composite visual presentation moves so that the display visual information shifts to adjust to changing alignments of the goggles and display.

The present invention provides a number of important technical advantages. One example of an important technical advantage is that goggles or other types of head gear allows an end user to have an enhanced visual experience by supplementing presentation of a primary display. A composited visual image is provided by allowing the end user to have direct viewing of an external display, such as a television, with peripheral images overlaid relative to the external display by the goggles while maintaining composition boundaries in real time during changing viewing angles, aspect ratios and distance. Compositing goggle images with peripheral display images is supported on a real time basis without end user inputs by automated use of reference points at the peripheral display that are detected by the goggles. In addition to providing see through portions of the goggles to support viewing of a peripheral display, reference points marked at other peripheral devices allow the end user to readily see and use physical devices not visible with virtual reality goggles that do not allow view outside of the goggle display.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a dynamically composited information handling system augmented reality at a primary display;

FIG. 2 depicts a view through goggles that augments an external display presentation with a virtual reality presentation; and

FIG. 3 depicts an example of images presented at goggles to augment an external display presentation with an augmented virtual reality presentation.

### DETAILED DESCRIPTION

Dynamically compositing visual images with goggles to supplement a primary display provides enhanced information handling system interactions. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

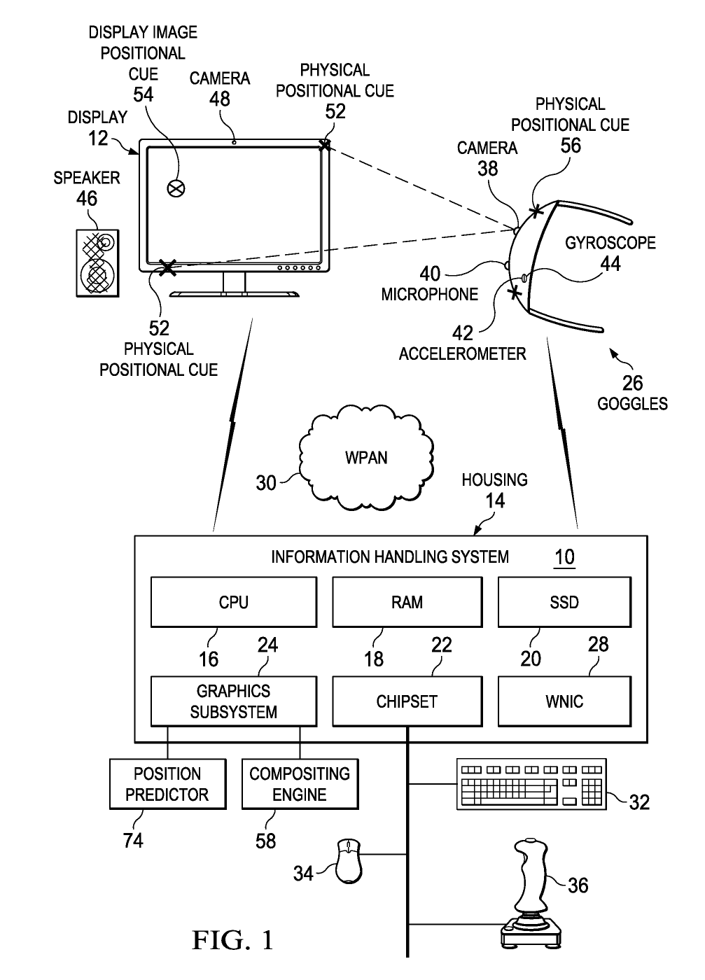

Referring now to FIG. 1, a block diagram depicts a dynamically composited information handling system 10 augmented reality at a primary display 12. Information handling system 10 processes information with processing components disposed in a housing 14. For example, a central processing unit (CPU) 16 executes instructions stored in random access memory (RAM) 18 and retrieved from persistent memory, such as a game application solid state drive (SSD) 20. A chipset 22 coordinates operation of the processing components to have visual information communicated to a graphics subsystem 24, which generates pixel information that supports presentation of visual images at display 12 and goggles 26. The visual information is communicated to display 12 and goggles 26 by a cable connection, such as a DisplayPort or other graphics cable, or by a wireless connection through a wireless network interface card (WNIC) 28, such as through a wireless personal area network (WPAN) 30. An end user interacts with information handling system 10 through a variety of input devices, such as a keyboard 32, a mouse 34 and a joystick 36. Although the example embodiment depicts information handling system 10 has having separate peripheral display 12, keyboard 32, mouse 34, and joystick 36, in alternative embodiments, portable information handling systems may integrate one or more of the peripherals into housing 14.

Goggles 26 present visual information to an end user who wears the goggles proximate to his eyes. In the example embodiment, goggles 26 are managed by graphics subsystem 24 as a secondary display to external peripheral display 12, such as with display controls available from the WINDOWS operating system. Goggles 26 include a camera 38 that captures visual images along one or more predetermined axis, such as directly in front of goggles 26 or at the eyes of an end user wearing goggles 26 to monitor pupil movement. Goggles 26 include a microphone 40 that captures sounds made by an end user wearing goggles 26 and other nearby sounds, such as the output of speakers 46 interfaced with information handling system 10. Goggles 26 include an accelerometer 42 that detects accelerations of goggles 26 and a gyroscope that detects rotational movement of goggles 26, such as might be caused by an end user wearing goggles 26. The output of camera 38, microphone 40, accelerometer 42 and gyroscope 44 is provided to information handling system 10 through WPAN 30, and may also be used locally at goggles 26 to detect positional cues as set forth below. Display 12 includes an integrated camera 48 that captures images in front of display 12, such as images of an end user wearing goggles 26.

Information handling system 10 includes a compositing engine 50 that coordinates the presentation of visual images at display 12 and goggles 26 to provide an augmented virtual reality for an end user wearing goggles 26. Although compositing engine 50 is depicted as a firmware module executing in graphics subsystem 24, in alternative embodiments compositing engine 50 may execute as software on CPU 16, as firmware in goggles 26 or a distributed module having functional elements distributed between CPU 16, graphics subsystem 24 and goggles 26. Composting engine 50 determines the relative position of goggles 26 to display 12 and dynamically modifies visual images at goggles 26 to supplement the presentation of visual information at display 12. For example, goggles 26 frame the position of display 12 so that goggles 26 present information only outside of the frame. Alternatively, goggles 26 display one type of visual image outside the frame defined by the position of display 12 and another type of visual image within the frame of display 12, such as by blending images of goggles 26 and display 12 within the frame of display 12 and presenting a primary image with goggles 26 outside of the frame. In one alternative embodiment, a darkening surface within goggles 26 forms a frame around display 12 so that images from display 12 pass through goggles 26 but external light outside of the frame of display 12 does not pass through goggles 26.

Compositing engine 50 determines the relative position of goggles 26 to display 12 with a variety of positional cues detected by sensors at display 12 and goggles 26. One example of positional cues is physical position cue 52, which marks the physical housing boundary of display 12, such as with one or more infrared lights placed in the bezel of display 12 proximate but external to an LCD panel that presents images at display 12. Camera 38 in goggles 26 capture an image with physical positional cues 52 so that the viewing angle of goggles 26 relative to display 12 is provided by the angular position of physical positioning cues 52 in the capture image, and the distance between display 12 and goggles 26 is provided by the angle between the positioning cues 52. Another example of positioning cues is a display image positional cue presented in display 12 and captured by camera 38 of goggles 26. Compositing engine 50 manages the type of displayed positional cue 54 to provide optimized position detection. In one example embodiment, display image positional cue 54 is presented with infrared light not visible to an end user wearing goggles 26, and includes motion cues that indicate predictive information about motion expected at goggles 26. For example, an end user playing a game who is about to get attacked from the left side will likely respond with a rapid head movement to the left; display image positional cue may include an arrow that indicates likely motion to goggles 26 so that a processor of goggles 26 that dynamically adjusts images on goggles 26 will prepare to adapt to the rapid movement. Another example of positioning cues are physical positional cues 56 located on the exterior of goggles 26 and detected by camera 48 to indicated viewing angle and distance information. In various embodiments, various combinations of positioning cues may be used to provide positional information between goggles 26 and display 12.

In addition to visual positioning cues, other types of sensors may provide positioning cues to aid in the alignment of visual images of display 12 and goggles 26 in a desired manner. A position predictor 74 applies information sensed by other types of sensors to predict motion of goggles 26 relative to display 12. Sounds detected by microphone 40 may indicate an upcoming position change, such as by increased motion during times of excitement indicated by shouting, or stereoscopic indications that draw an end user's attention in a direction and cause the end user to look in that direction. Visual images of camera 38 taken of an end user's eyes may indicate an upcoming position change based upon dilation of pupils that indicate excitement of changes of eye direction that prelude head movements. In both examples, indications of increased excitement that are often preludes to head movement may be used to pre-allocate processing resources to more rapidly detect and react to movements when the movements occur. Accelerometer 42 and gyroscope 44 detect motion rapidly to provide predictive responses to movement before images from visual positional cues are analyzed and applied. Other positioning cues may be provided by an application as part of visual and audio presentation, such as visual images and sounds not detectable by an end user but detected by microphone 40 and camera 38 during presentation of the visual and audio information. Additional positioning cues may be provided by radio signal strength of goggles 26 for WPAN 30, which indicates a distance to display 12.

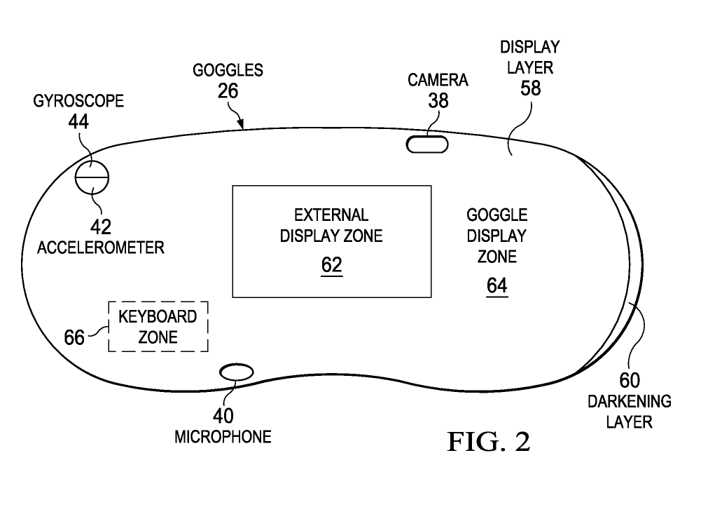

Referring now to FIG. 2, a view through goggles 26 is depicted that augments an external display 12 presentation with a virtual reality presentation. Goggles 26 have a display layer 58 that presents visual images provided from information handling system 10. For example, display layer 58 generates visual images with liquid crystal display pixels that are illuminated with a backlight, such as for a virtual reality display environment, or that are illuminated with external light that passes through goggles 26, such as for an augmented reality environment. A darkening layer 60 selectively darkens all or portions of the goggle viewing area to prevent external light from entering into goggles 26. In one example embodiment, an external display zone 62 aligns with an external display 12 to allow images from external display 12 to pass through goggles 26 to an end user for viewing, and a goggle display zone 64 located outside and surrounding external display zone 62 presents images with display layer 58. Compositing engine 50 coordinates the generation of visual images by display 12 and goggles 26 so that an end user experiences the full capabilities of external display 12 with supplementation by visual images generated by goggles 26. Darkening layer 60 selectively enhances the presentation of goggle 26 visual images by selectively restricting external visual light. In one embodiment, a keyboard zone 66 or other input peripheral zones are defined to highlight the location of external peripheral devices so that an end user can rapidly locate and access the peripheral devices as needed. For example, keyboards or other peripheral devices include unique physical positional cues that are detected in a manner similar to the positional cues of display 12. These physical cues allow compositing engine 50 to pass through light associated with the peripheral device locations or to generate a visual image at goggles 26 that show virtual peripheral devices that guide an end user to the physical peripheral device.

During operation, an end user puts goggles 26 on over his eyes and looks at display 12 through goggles 26. Compositing engine 50 generates visual images at display 12, such as images associated with a computer game. Compositing engine 50 determines the position of goggles 26 relative to display 12 based upon detection of positional cues by camera sensors, and allows visual images generated at display 12 to pass through external display zone 62, which corresponds to the position of display 12 relative to an end user wearing goggles 26. In one embodiment, goggles 26 do not present visual images in external display zone 62; in an alternative embodiment, goggles 26 present visual images in external display zone 62 that supplements visual images presented by display 12. Compositing engine 50 generates goggle visual information for presentation in goggle display zone 64. External display zone 62 changes position as an end user moves relative to display 12 so that external display 12 visual information passes through goggles 26 in different positions and goggle 26 visual information is presented in different areas. Movement of external display zone 62 is managed by compositing engine 50 in response to positional cues sensed by camera 38 and/or 48. Compositing engine 50 predicts the position of external display zone 62 between positional cue sensing operations by applying accelerometer and gyroscope sensed values, such as by a prediction of goggle 26 position changes based on detected accelerations and axis changes. In one embodiment, if an end user looks completely away from display 12, compositing engine 50 presents the information of display 12 as goggle visual information centered in goggles 26.

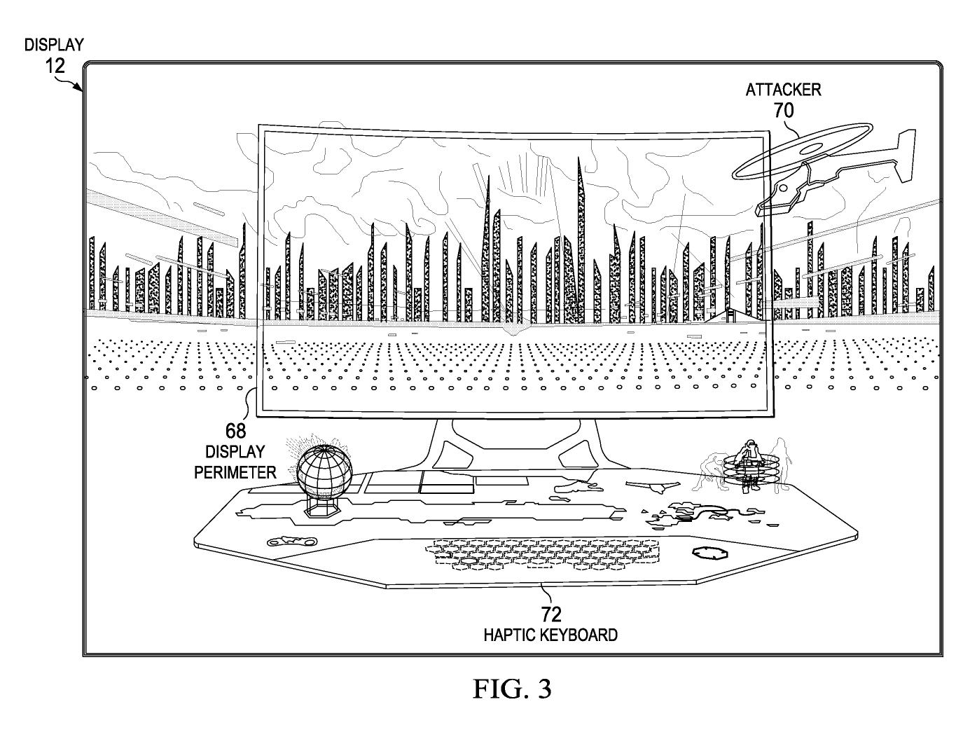

Referring now to FIG. 3, an example depicts images presented at goggles 26 to augment an external display 12 presentation with an augmented virtual reality presentation. A display perimeter 68 corresponds to the external display zone 62 with all of the visual images presented within display perimeter 68 generated by display 12 and passed through goggles 26 to the end user wearing goggles 26. The visual images presented outside of display perimeter 68 are generated by goggles 26. In the example depicted by FIG. 3, a video game depicts a city skyline in display 12 and extends the skyline with goggle visual images outside of display 12. An attacker 70 is depicted primarily by goggle visual images just as the attacker enters into display 12 so than an end user is provided with peripheral vision not available from just display 12. If the end user turns his head to view the attacker 70, then the visual image of attacker 70 moves onto the visual images presented by display 12 as the display perimeter 68 moves in the direction of the attacker 70 and the movement is detected through changes in the relative position of positional cues. As is depicted by FIG. 3, 3D graphics may be supported by goggles 26 by using eye tracking with camera 38 to drive a 3D parallax experience. A haptic keyboard 72 has 3 dimensional figures presented by goggles 26 to support more rapid end user interactions. In one embodiment, keyboard 72 is a projected keyboard that the end user views through goggles 26 and interacts with through finger inputs detected by camera 38. Physical input devices, such as haptic keyboard 72 may be highlighted with goggle visual images by placing positional cues on the physical device. A projected keyboard presented with goggles 26 may have finger interactions highlighted by physical cues on gloves worn by the end user or by depth camera interaction with the end user hands to allow automated recognition of the end user hands in a virtual space associated with end user inputs. Similarly, other virtual projected devices presented by goggles 26 may be used, such as projected joysticks, mice, etc. . . . .

Although the present invention has been described in detail, it should be understood that various changes, substitutions and alterations can be made hereto without departing from the spirit and scope of the invention as defined by the appended claims.

What is claimed is:

1. An information handling system comprising:
a housing;
processing components disposed in the housing and operable to cooperate to process information;
a display interfaced with the processing components and operable to present the information as visual images;
goggles interfaced with the processing components and operable to present the information as visual images;
positional cues relating a position of the display relative to a position of the goggles;
a position detector associated with the goggles and operable to detect the positional cues; and
a compositing engine interfaced with the positional detector and operable to manage generation of the visual images at the goggles relative to the visual images of the display based at least in part upon the positional cues detected by the position detector.

2. The information handling system of claim 1 wherein the positional cues comprise one or more predetermined markers presented with the visual images at the display and the position detector comprises a camera integrated with the goggles and operable to capture an image of the predetermined markers.

3. The information handling system of claim 1 wherein the positional cues comprise one or more physical infrared markers embedded in predetermined positions of the display and the position detector comprises a camera integrated with the goggles and operable to capture an image of the infrared markers.

4. The information handling system of claim 1 wherein the positional cues comprise one or more physical markers embedded in predetermined positions of the goggles and the position detector comprises a camera integrated with the display and operable to capture an image of the physical markers.

5. The information handling system of claim 1 further comprising:
a darkening layer integrated in the goggles and operable to selectively darken to restrict light from passing through the goggles to an end user wearing the goggles;
wherein the compositing engine manages generation of the visual images at the goggles at least in part by selectively darkening the darkening layer except at positions where the display images pass through the goggles.

6. The information handling system of claim 1 further comprising:
one or more sensors disposed in the goggles; and
a position predictor interfaced with the sensors and the compositing engine, the position predictor operable to apply one or more conditions sensed by the one or more sensors and to predict changes in position of the goggles relative to the display for use by the compositing engine.

7. The information handling system of claim 6 wherein the one or more sensors comprise a gyroscope operable to detect rotational movement of the goggles.

8. The information handling system of claim 6 wherein the one or more sensors comprise a camera operable to detect eye position relative to the goggles.

9. The information handling system of claim 6 wherein the one or more sensors comprise a microphone operable to detect noises.

10. The information handling system of claim 6 wherein the one or more sensors comprise an accelerometer operable to detect accelerations associated with movement of the goggles.

11. A method for presenting visual images at goggles, the method comprising:
presenting visual images at a display, the visual images generated by an information handling system;
detecting a position of the goggles relative to the display;
generating goggle visual images with the information handling system based upon the detected position, the goggle visual images composited with the display visual images; and
presenting the goggle visual images at the goggles as a composite presentation with the display visual images.

12. The method of claim 11 wherein detecting a position of the goggles relative to the display further comprises:
capturing a positional cue integrated in the display using a sensor integrated in the goggles; and
communicating positional information related to the captured positional cue from the goggles to the information handling system.

13. The method of claim 12 wherein the positional cue comprises a predetermined image included in the visual images presented at the display.

14. The method of claim 12 wherein the positional cue comprises a predetermined marker disposed in a housing of the display.

15. The method of claim 11 wherein detecting a position of the goggles relative to the display further comprises:
capturing a positional cue integrated in the goggles using a sensor integrated in the display; and
communicating positional information related to the captured positional cue from the display to the information handling system.

16. The method of claim 11 further comprising:
performing inputs to the information handling system with an input device;
detecting a position of the goggles relative to the input device; and
generating the goggle visual images with the information handling system based upon the detected input device position, the goggle visual images including an indication of the input device position.

17. The method of claim 11 wherein detecting a position of the goggles relative to the display further comprises detecting accelerations at the goggles with an accelerometer disposed in the goggles.

18. The method of claim 11 wherein detecting a position of the goggles relative to the display further comprises detecting rotational movement at the goggles with a gyroscope disposed in the goggles.

19. The method of claim 11 wherein detecting a position of the goggles relative to the display further comprises detecting eye positions of an end user wearing the goggles to predict motion of the goggles.

20. The method of claim 11 wherein detecting a position of the goggles relative to the display further comprises detecting distance from the goggles to the display with radio signal strength for radio signals transmitted between the goggles and the display.
